(19) United States
(12) Patent Application Publication
(10) Pub. No.: US 2020/0255646 A1
(43) Pub. Date: Aug. 13, 2020

(54) COMPOSITIONS INCLUDING AMORPHOUS FLUOROPOLYMERS AND METHODS OF USING THE SAME

(71) Applicant: 3M INNOVATIVE PROPERTIES COMPANY, St. Paul, MN (US)

(72) Inventors: Shireen A. Mamun, Woodbury, MN (US); Claude Lavallée, Maplewood, MN (US); Dawn H. McArthur, Woodbury, MN (US)

(21) Appl. No.: 15/774,324

(22) PCT Filed: Nov. 11, 2016
(86) PCT No.: PCT/US2016/061586

§ 371 Date: May 8, 2018

Related U.S. Application Data
(60) Provisional application No. 62/254,965, filed on Nov. 13, 2015.

(51) Int. Cl. C08L 27/20; C08L 27/18; C08L 27/16

(52) U.S. Cl. CPC C08L 27/20; C08G 77/445; C08L 27/16; C08L 27/18

(57) ABSTRACT

A composition includes a first amorphous fluoropolymer having a first Mooney viscosity ML 1+10 @ 121° C. less than 60 and a second amorphous fluoropolymer having a second Mooney viscosity ML 1+10 @ 121° C. greater than 80. The composition further includes at least one of a non-fluorinated, thermoplastic polymer as a major component of the composition or a polymer processing additive synergist. A method of reducing melt defects during the extrusion of a polymer is also provided. Use of a combination of the first and second amorphous fluoropolymers as a polymer processing additive is also provided.

### CROSS REFERENCE TO RELATED APPLICATION

This application claims priority to U.S. Provisional Application No. 62/254,965, filed Nov. 13, 2015, the disclosure of which is incorporated by reference in its entirety herein.

### BACKGROUND

Extrusion of polymeric materials in the formation and shaping of articles is a major segment of the plastic or polymeric articles industry. The quality of the extruded article and the overall success of the extrusion process are typically influenced by the interaction of the fluid material with the extrusion die. For any melt-processable thermoplastic polymer composition, there exists a critical shear rate above which the surface of the extrudate becomes rough or distorted and below which the extrudate will be smooth. See, for example, R. F. Westover, Melt Extrusion, Encyclopedia of Polymer Science and Technology, vol. 8, pp. 573-81 (John Wiley & Sons 1968). The desire for a smooth extrudate surface competes with, and must be optimized with respect to, the economic advantages of extruding a polymer composition at the fastest possible speed (for example at high shear rates).

At low shear rates, defects in extruded thermoplastics may take the form of “sharkskin”, which is a loss of surface gloss that in more serious manifestations appears as ridges running more or less transverse to the extrusion direction. At higher rates, the extrudate can undergo “continuous melt fracture” becoming grossly distorted. At rates lower than those at which continuous melt fracture is first observed, certain thermoplastics can also suffer from “cyclic melt fracture”, in which the extrudate surface varies from smooth to rough.

There are other problems often encountered during the extrusion of thermoplastic polymers. They include a build-up of the polymer at the orifice of the die (known as die build up or die drool), high back pressure during extrusion runs, and excessive degradation or low melt strength of the polymer due to high extrusion temperatures. These problems slow the extrusion process either because the process must be stopped to clean the equipment or because the process must be run at a lower speed.

The addition of fluoropolymers can at least partially alleviate melt defects in extrudable thermoplastic polymers. Fluoropolymers that can be used as polymer processing additive include those described, for example, in U.S. Pat. Nos. 5,015,693 and 4,855,013 (Duchesne et al.), U.S. Pat. No. 5,710,217 (Blong et al.), U.S. Pat. No. 6,277,919 (Dillon et al.), U.S. Pat. No. 6,599,982 (Oriani), and U.S. Pat. No. 7,001,951 (Chapman, Jr.).

### SUMMARY

The use of a combination of amorphous fluoropolymers as a polymer processing additive is effective in reducing melt defects such as sharkskin in thermoplastic polymers. In some cases, when the difference in the Mooney viscosities of two amorphous fluoropolymers in a blend is greater than 20 or when the Mooney viscosity of one of the amorphous fluoropolymers is at least 80, the blend of amorphous fluoropolymers is more effective in reducing melt defects than a comparative blend of amorphous fluoropolymers in which no amorphous fluoropolymer in the blend has a Mooney viscosity higher than 80 or in which the difference in Mooney viscosities is less than 20, even when the Mooney viscosity of the blend and the comparative blend is the same.

Thus, in one aspect, the present disclosure provides a composition including at least one of a non-fluorinated thermoplastic polymer as a major component of the composition or a polymer processing additive synergist. The composition further includes a blend of a first amorphous fluoropolymer having a first Mooney viscosity and a second amorphous fluoropolymer having a second Mooney viscosity. The first Mooney viscosity ML 1+10 @ 121° C. is less than 60, and the second Money viscosity ML 1+10 @ 121° C. is greater than 80. In some embodiments, the composition includes the non-fluorinated thermoplastic polymer. In some embodiments, the composition includes the polymer processing additive synergist. In some embodiments, the composition includes both the non-fluorinated thermoplastic polymer and the polymer processing additive synergist.

In another aspect, the present disclosure provides a method of reducing melt defects in a non-fluorinated thermoplastic polymer. The method includes combining the non-fluorinated, thermoplastic polymer, a first amorphous fluoropolymer having a first Mooney viscosity, and a second amorphous fluoropolymer having a second Mooney viscosity to form an extrudable composition and extruding the extrudable composition. The first Mooney viscosity ML 1+10 @ 121° C. is less than 60, and the second Money viscosity ML 1+10 @ 121° C. is greater than 80.

In another aspect, the present disclosure provides the use of a combination of amorphous fluoropolymers as a polymer processing additive. The combination includes a first amorphous fluoropolymer having a first Mooney viscosity and a second amorphous fluoropolymer having a second Mooney viscosity. The first Mooney viscosity ML 1+10 @ 121° C. is less than 60, and the second Money viscosity ML 1+10 @ 121° C. is greater than 80.

In some embodiments of the aforementioned aspects, amounts of the first amorphous fluoropolymer and the second amorphous fluoropolymer are selected such that a blend of the first amorphous fluoropolymer and the second amorphous fluoropolymer further has a Mooney viscosity ML 1+10 @ 121° C. in a range from 30 to 120.

In this application:

Terms such as “a”, “an” and “the” are not intended to refer to only a singular entity, but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

“Alkyl group” and the prefix “alk-” are inclusive of both straight chain and branched chain groups and of cyclic groups having up to 30 carbons (in some embodiments, up to 20, 15, 12, 10, 8, 7, 6, or 5 carbons) unless otherwise specified. Cyclic groups can be monocyclic or polycyclic and, in some embodiments, have from 3 to 10 ring carbon atoms.

The term “perfluoroalkyl group” includes linear, branched, and/or cyclic alkyl groups in which all C—H bonds are replaced by C—F bonds.

The phrase “interrupted by one or more —O— groups”, for example, with regard to an alkyl, alkylene, or arylalkylene refers to having part of the alkyl, alkylene, or arylalkylene on both sides of the one or more —O— groups. An example of an alkylene that is interrupted with one —O— group is —CH₂—CH₂—O—CH₂—CH₂—.

The term “aryl” as used herein includes carbocyclic aromatic rings or ring systems, for example, having 1, 2, or 3 rings, optionally containing at least one heteroatom (e.g., O, S, or N) in the ring, and optionally substituted by up to five substituents including one or more alkyl groups having up to 4 carbon atoms (e.g., methyl or ethyl), alkoxy having up to 4 carbon atoms, halo (i.e., fluoro, chloro, bromo or iodo), hydroxy, or nitro groups. Examples of aryl groups include phenyl, naphthyl, biphenyl, fluorenyl as well as furyl, thienyl, oxazolyl, and thiazolyl. “Arylalkylene” refers to an “alkylene” moiety to which an aryl group is attached. “Alkylarylene” refers to an “arylene” moiety to which an alkyl group is attached.

By ‘synergist’ is meant a compound that allows the use of a lower amount of the fluoropolymer as a polymer processing additive while achieving essentially the same improvement in extrusion and processing properties of the extrudable polymer as if a higher amount of the fluoropolymer polymer processing additive was used.

It should be understood that the term “polymer processing additive synergist” per se, as used herein, does not include a fluoropolymer or the non-fluorinated thermoplastic polymer. In other words, a polymer processing additive synergist per se does not include the polymer processing additive or the host polymer.

All numerical ranges are inclusive of their endpoints and nonintegral values between the endpoints unless otherwise stated (e.g., 1 to 5 includes 1, 1.5, 2, 2.75, 3, 3.80, 4, 5, etc.).

Various aspects and advantages of embodiments of the present disclosure have been summarized. The above Summary is not intended to describe each illustrated embodiment or every implementation of the present disclosure.

### DETAILED DESCRIPTION

The composition, method, and use according to the present disclosure includes a combination of a first amorphous fluoropolymer having a first Mooney viscosity and a second amorphous fluoropolymer having a second Mooney viscosity. The combination may be a blend (or intimate mixture) of a first amorphous fluoropolymer having a first Mooney viscosity and a second amorphous fluoropolymer having a second Mooney viscosity. The first Mooney viscosity ML 1+10 @ 121° C. is less than 60, in some embodiments, in a range from 30 to 59, 31 to 59, 30 to 55, or 31 to 55. The second Mooney viscosity ML 1+10 @ 121° C. is greater than 80, in some embodiments, at least 90, at least 95, or at least 100. In some embodiments, the second Mooney viscosity ML 1+10 @ 121° C. is in a range from 81 to 160, 85 to 160, 90 to 160, 95 to 160, 85 to 155, or 85 to 125. Mooney viscosities can be controlled, for example, by controlling molecular weight and branching in the fluoropolymer. Mooney viscosity is determined using ASTM D1646-06 Part A by a MV 2000 instrument (available from Alpha Technologies, Ohio, USA) using a large rotor (ML 1+10) at 121° C. Mooney viscosities specified above are in Mooney units. In some embodiments, as shown in the examples, below, when the Mooney viscosity ML 1+10 @ 121° C. of one of the amorphous fluoropolymers is at least 80, the blend of amorphous fluoropolymers is more effective in reducing melt defects than a comparative blend of amorphous fluoropolymers in which no amorphous fluoropolymer in the blend has a Mooney viscosity ML 1+10 @ 121° C. higher than 80, even when the Mooney viscosity of the blend and the comparative blend is the same.

The difference between the first Mooney viscosity ML 1+10 @ 121° C. and the second Mooney viscosity ML 1+10 @ 121° C. is greater than 20, in some embodiments, greater than 30, 40, or 50. In some embodiments, the difference between the first Mooney viscosity ML 1+10 @ 121° C. and the second Mooney viscosity ML 1+10 @ 121° C. is up to 120, in some embodiments, up to 100, 90, 80, or 75. In some embodiments, as shown in the examples, below, when the difference in the Mooney viscosities of two amorphous fluoropolymers in a blend is greater than 20 (in some embodiments, at least 30, 40, or 50), the blend of amorphous fluoropolymers is more effective in reducing melt defects than a comparative blend of amorphous fluoropolymers in which the difference in Mooney viscosities is less than 20, even when the Mooney viscosity ML 1+10 @ 121° C. of the blend and the comparative blend is the same.

Compositions, methods, and uses according to the present disclosure may include three or more amorphous fluoropolymers having different Mooney viscosities. However, at least one first amorphous fluoropolymer has a first Mooney viscosity ML 1+10 @ 121° C. less than 60, in some embodiments, in a range from 30 to 59, 31 to 59, 30 to 55, or 31 to 55, and at least one second amorphous fluoropolymer has a second Mooney viscosity ML 1+10 @ 121° C. greater than 80, in some embodiments, at least 90, at least 95, at least 100, or in a range from 81 to 160, 85 to 160, 90 to 160, 95 to 160, or 85 to 155.

In some embodiments of the composition, method, or use according to the present disclosure, a weight ratio of the first amorphous fluoropolymer and the second amorphous fluoropolymer is in a range from 10:90 to 90:10, in some embodiments, 20:80 to 80:20 or 30:70 to 70:30. In embodiments in which the second Mooney viscosity ML 1+10 @ 121° C. is greater than 90, 95, or 100, the second amorphous fluoropolymer may be present in an amount up to 75, 70, 60, 50, 40, 30, or 20 percent by weight, based on the total weight of the first and second amorphous fluoropolymers. In embodiments in which the second Mooney viscosity ML 1+10 @ 121° C. is greater than 80 and up to 90, the second amorphous fluoropolymer may be present in an amount up to 80, 75, 70, 60, or 55 percent by weight, based on the total weight of the first and second amorphous fluoropolymers. It should be understood that the first amorphous fluoropolymer would then make up the remainder of the total weight of the first and second fluoropolymer in these cases. The weight ratio of the first amorphous fluoropolymer and the second amorphous fluoropolymer may be selected, for example, to achieve a Mooney viscosity ML 1+10 @ 121° C. of a blend of the first and second amorphous fluoropolymers in a range from 30 to 120.

In some embodiments of the composition, method, and use according to the present disclosure, a blend of the first amorphous fluoropolymer and the second amorphous fluoropolymer has a Mooney viscosity ML 1+10 @ 121° C. in a range from 30 to 120, 30 to 110, 40 to 100, 30 to 90, 40 to 90, 30 to 60, 30 to 40, about 60 to about 90, about 60 to about 80, about 90 to about 100, or about 65 to about 75.

Amorphous fluoropolymers typically do not exhibit a melting point. They typically have glass transitions temperatures below room temperature and exhibit little or no crystallinity at room temperature. Amorphous fluoropolymers useful as polymer processing additives include homopolymers and/or copolymers of fluorinated olefins. In some embodiments, the homopolymers or copolymers can have a fluorine atom-to-carbon atom ratio of at least 1:2, in some embodiments at least 1:1; and/or a fluorine atom-to-hydrogen atom ratio of at least 1:1.5.

Amorphous fluoropolymers useful for practicing the present disclosure can comprise interpolymerized units derived from at least one partially fluorinated or perfluorinated ethylenically unsaturated monomer represented by formula R^{a}CF═CR^{a}₂, wherein each R^{a} is independently fluoro, chloro, bromo, hydrogen, a fluoroalkyl group (e.g. perfluoroalkyl having from 1 to 8, 1 to 4, or 1 to 3 carbon atoms), a fluoroalkoxy group (e.g. perfluoroalkoxy having from 1 to 8, 1 to 4, or 1 to 3 carbon atoms, optionally interrupted by one or more oxygen atoms), alkyl or alkoxy of from 1 to 8 carbon atoms, aryl of from 1 to 8 carbon atoms, or cyclic saturated alkyl of from 1 to 10 carbon atoms. Examples of useful fluorinated monomers represented by formula R^{a}CF═CR^{a}₂ include vinylidene fluoride (VDF), tetrafluoroethylene (TFE), hexafluoropropylene (HFP), chlorotrifluoroethylene, 2-chloropentafluoropropene, dichlorodifluoroethylene, 1,1-dichlorofluoroethylene, 1-hydropentafluoropropylene, 2-hydropentafluoropropylene, perfluoroalkyl perfluorovinyl ethers, and mixtures thereof.

In some embodiments, at least one of the first or second amorphous fluoropolymers includes units from one or more monomers independently represented by formula CF₂═CFORf, wherein Rf is perfluoroalkyl having from 1 to 8, 1 to 4, or 1 to 3 carbon atoms, optionally interrupted by one or more —O— groups. Perfluoroalkoxyalkyl vinyl ethers suitable for making an amorphous fluoropolymer include those represented by formula CF₂═CF(OCₙF₂ₙ)_{z}ORf₂, in which each n is independently from 1 to 6, z is 1 or 2, and Rf₂ is a linear or branched perfluoroalkyl group having from 1 to 8 carbon atoms and optionally interrupted by one or more —O— groups. In some embodiments, n is from 1 to 4, or from 1 to 3, or from 2 to 3, or from 2 to 4. In some embodiments, n is 1 or 3. In some embodiments, n is 3. CₙF₂ₙ may be linear or branched. In some embodiments, CₙF₂ₙ can be written as (CF₂)ₙ, which refers to a linear perfluoroalkylene group. In some embodiments, CₙF₂ₙ is —CF₂—CF₂—CF₂—. In some embodiments, CₙF₂ₙ is branched, for example, —CF₂—CF(CF₃)—. In some embodiments, (OCₙF₂ₙ)_{z} is represented by —O—(CF₂)₁₋₄—[O(CF₂)₁₋₄]₀₋₁. In some embodiments, Rf₂ is a linear or branched perfluoroalkyl group having from 1 to 8 (or 1 to 6) carbon atoms that is optionally interrupted by up to 4, 3, or 2 —O— groups. In some embodiments, Rf₂ is a perfluoroalkyl group having from 1 to 4 carbon atoms optionally interrupted by one —O— group. Suitable monomers represented by formula CF₂═CFORf and CF₂═CF(OCₙF₂ₙ)_{z}ORf₂ include perfluoromethyl vinyl ether, perfluoroethyl vinyl ether, perfluoropropyl vinyl ether, CF₂═CFOCF₂OCF₃, CF₂═CFOCF₂OCF₂CF₃, CF₂═CFOCF₂CF₂OCF₃, CF₂═CFOCF₂CF₂CF₂OCF₃, CF₂═CFOCF₂CF₂CF₂CF₂OCF₃, CF₂═CFOCF₂CF₂OCF₂CF₃, CF₂═CFOCF₂CF₂CF₂OCF₂CF₃, CF₂═CFOCF₂CF₂CF₂CF₂OCF₂CF₃, CF₂═CFOCF₂CF₂OCF₂OCF₃, CF₂═CFOCF₂CF₂OCF₂CF₂OCF₃, CF₂═CFOCF₂CF₂OCF₂CF₂CF₂OCF₃, CF₂═CFOCF₂CF₂OCF₂CF₂CF₂CF₂OCF₃, CF₂═CFOCF₂CF₂OCF₂CF₂CF₂CF₂CF₂OCF₃, CF₂═CFOCF₂CF₂(OCF₂)₃OCF₃, CF₂═CFOCF₂CF₂(OCF₂)₄OCF₃, CF₂═CFOCF₂CF₂OCF₂OCF₂OCF₃, CF₂═CFOCF₂CF₂OCF₂CF₂CF₃CF₂═CFOCF₂CF₂OCF₂CF₂OCF₂CF₂CF₃, CF₂═CFOCF₂CF(CF₃)—O—C₃F₇ (PPVE-2), CF₂═CF(OCF₂CF(CF₃))₂—O—C₃F₇ (PPVE-3), and CF₂═CF(OCF₂CF(CF₃))₃—O—C₃F₇ (PPVE-4). Many of these perfluoroalkoxyalkyl vinyl ethers can be prepared according to the methods described in U.S. Pat. No. 6,255,536 (Worm et al.) and U.S. Pat. No. 6,294,627 (Worm et al.).

Perfluoroalkyl alkene ethers and perfluoroalkoxyalkyl alkene ethers may also be useful for making an amorphous polymer for the composition, method, and use according to the present disclosure. In addition, the amorphous fluoropolymers may include interpolymerized units of fluoro (alkene ether) monomers, including those described in U.S. Pat. No. 5,891,965 (Worm et al.) and U.S. Pat. No. 6,255,535 (Schulz et al.). Such monomers include those represented by formula CF₂═CF(CF₂)ₘ—O—R_{f}, wherein m is an integer from 1 to 4, and wherein R_{f} is a linear or branched perfluoroalkylene group that may include oxygen atoms thereby forming additional ether linkages, and wherein R_{f} contains from 1 to 20, in some embodiments from 1 to 10, carbon atoms in the backbone, and wherein R_{f} also may contain additional terminal unsaturation sites. In some embodiments, m is 1. Examples of suitable fluoro (alkene ether) monomers include perfluoroalkoxyalkyl allyl ethers such as CF₂═CFCF₂—O—CF₃, CF₂═CFCF₂—O—CF₂—O—CF₃, CF₂═CFCF₂—O—CF₂CF₂—O—CF₃, CF₂═CFCF₂—O—CF₂CF₂—O—CF₂—O—CF₂CF₃, CF₂═CFCF₂—O—CF₂CF₂—O—CF₂CF₂CF₂—O—CF₃, CF₂═CFCF₂—O—CF₂CF₂—O—CF₂CF₂—O—CF₂—O—CF₃, CF₂═CFCF₂CF₂—O— CF₂CF₂CF₃. Suitable perfluoroalkoxyalkyl allyl ethers include those represented by formula CF₂═CFCF₂(OCₙF₂ₙ)_{z}ORf₂, in which n, z, and Rf₂ are as defined above in any of the embodiments of perfluoroalkoxyalkyl vinyl ethers. Examples of suitable perfluoroalkoxyalkyl allyl ethers include CF₂═CFCF₂OCF₂CF₂OCF₃, CF₂═CFCF₂OCF₂CF₂CF₂OCF₃, CF₂═CFCF₂OCF₂OCF₃, CF₂═CFCF₂OCF₂OCF₂CF₃, CF₂═CFCF₂OCF₂CF₂CF₂CF₂OCF₃, CF₂═CFCF₂OCF₂CF₂OCF₂CF₃, CF₂═CFCF₂OCF₂CF₂CF₂OCF₂CF₃, CF₂═CFCF₂OCF₂CF₂CF₂CF₂OCF₂CF₃, CF₂═CFCF₂OCF₂CF₂OCF₂OCF₃, CF₂═CFCF₂OCF₂CF₂OCF₂CF₂OCF₃, CF₂═CFCF₂OCF₂CF₂OCF₂CF₂CF₂OCF₃, CF₂═CFCF₂OCF₂CF₂OCF₂CF₂CF₂CF₂OCF₃, CF₂═CFCF₂OCF₂CF₂OCF₂CF₂CF₂CF₂CF₂OCF₃, CF₂═CFCF₂OCF₂CF₂(OCF₂)₃OCF₃, CF₂═CFCF₂OCF₂CF₂(OCF₂)₄OCF₃, CF₂═CFCF₂OCF₂CF₂OCF₂OCF₂OCF₃, CF₂═CFCF₂OCF₂CF₂OCF₂CF₂CF₃, CF₂═CFCF₂OCF₂CF₂OCF₂CF₂OCF₂CF₂CF₃, CF₂═CFCF₂OCF₂CF(CF₃)—O—C₃F₇, and CF₂═CFCF₂(OCF₂CF(CF₃))₂—O—C₃F₇. Many of these perfluoroalkoxyalkyl allyl ethers can be prepared, for example, according to the methods described in U.S. Pat. No. 4,349,650 (Krespan).

At least one of the first or second amorphous fluoropolymers may also comprise interpolymerized units derived from the interpolymerization of at least one monomer R^{a}CF═CR^{a}₂ with at least one non-fluorinated, copolymerizable comonomer represented by formula R^{b}₂C═CR^{b}₂, wherein each R^{b} is independently hydrogen, chloro, alkyl having from 1 to 8, 1 to 4, or 1 to 3 carbon atoms, a cyclic saturated alkyl group having from 1 to 10, 1 to 8, or 1 to 4 carbon atoms, or an aryl group of from 1 to 8 carbon atoms. Examples of useful monomers represented by formula R^{b}₂C═CR^{b}₂ include ethylene and propylene.

Perfluoro-1,3-dioxoles may also be useful to prepare the amorphous fluoropolymer disclosed herein. Perfluoro-1,3-dioxole monomers and their copolymers are described in U.S. Pat. No. 4,558,141 (Squires).

Examples of useful amorphous copolymers of fluorinated olefins are those derived, for example, from vinylidene fluoride and one or more additional olefins, which may or may not be fluorinated (e.g., represented by formula R^{a}CF═CR^{a}₂ or R^{b}₂C═CR^{b}₂). In some embodiments, useful fluoropolymers include copolymers of vinylidene fluoride with at least one terminally unsaturated fluoromonoolefin represented by formula R^{a}CF═CR^{a}₂ containing at least one fluorine atom on each double-bonded carbon atom. Examples of comonomers that can be useful with vinylidene fluoride include hexafluoropropylene, chlorotrifluoroethylene, 1-hydropentafluoropropylene, and 2-hydropentafluoropropylene. Other examples of amorphous fluoropolymers useful for practicing the present disclosure include copolymers of vinylidene fluoride, tetrafluoroethylene, and hexafluoropropylene or 1- or 2-hydropentafluoropropylene and copolymers of tetrafluoroethylene, propylene, and, optionally, vinylidene fluoride. In some embodiments, at least one of the first or second amorphous fluoropolymer is a copolymer of hexafluoropropylene and vinylidene fluoride. Such fluoropolymers are described in U.S. Pat. No. 3,051,677 (Rexford) and U.S. Pat. No. 3,318,854 (Honn, et al.) for example. In some embodiments, at least one of the first or second amorphous fluoropolymer is a copolymer of perfluoropropylene, vinylidene fluoride and tetrafluoroethylene. Such fluoropolymers are described in U.S. Pat. No. 2,968,649 (Pailthorp et al.), for example.

Amorphous fluoropolymers including interpolymerized units of VDF and HFP typically have from 30 to 90 percent by weight VDF units and 70 to 10 percent by weight HFP units. Amorphous fluoropolymers including interpolymerized units of TFE and propylene typically have from about 50 to 80 percent by weight TFE units and from 50 to 20 percent by weight propylene units. Amorphous fluoropolymers including interpolymerized units of TFE, VDF, and propylene typically have from about 45 to 80 percent by weight TFE units, 5 to 40 percent by weight VDF units, and from 10 to 25 percent by weight propylene units. Those skilled in the art are capable of selecting specific interpolymerized units at appropriate amounts to form an amorphous fluoropolymer. In some embodiments, polymerized units derived from non-fluorinated olefin monomers are present in the amorphous fluoropolymer at up to 25 mole percent of the fluoropolymer, in some embodiments up to 10 mole percent or up to 3 mole percent. In some embodiments, polymerized units derived from at least one of perfluoroalkyl vinyl ether or perfluoroalkoxyalkyl vinyl ether monomers are present in the amorphous fluoropolymer at up to 50 mole percent of the fluoropolymer, in some embodiments up to 30 mole percent or up to 10 mole percent.

In some embodiments, at least one of the first or second amorphous fluoropolymers useful or practicing the present disclosure is a TFE/propylene copolymer, a TFE/propylene/VDF copolymer, a VDF/HFP copolymer, a TFE/VDF/HFP copolymer, a TFE/perfluoromethyl vinyl ether (PMVE) copolymer, a TFE/CF₂═CFOC₃F₇ copolymer, a TFE/CF₂═CFOCF₃/CF₂═CFOC₃F₇ copolymer, a TFE/CF₂═C(OC₂F₅)₂ copolymer, a TFE/ethyl vinyl ether (EVE) copolymer, a TFE/butyl vinyl ether (BVE) copolymer, a TFE/EVE/BVE copolymer, a VDF/CF₂═CFOC₃F₇ copolymer, an ethylene/HFP copolymer, a TFE/HFP copolymer, a CTFE/VDF copolymer, a TFE/VDF copolymer, a TFE/VDF/PMVE/ethylene copolymer, or a TFE/VDF/CF₂═CFO(CF₂)₃OCF₃ copolymer.

In some embodiments, the first and/or second amorphous fluoropolymer useful for practicing the present disclosure includes long-chain branching. Such fluoropolymers are prepared by using modifiers such as bisolefins or halogen containing monoolefins during the polymerization reaction. See, for example, U.S. Pat. Appl. Pub. No. 2010/0311906 (Lavallée et al.) and U.S. Pat. No. 7,375,157 (Amos et al.), respectively. Fluoropolymers with long-chain branching can effectively reduce melt fracture during extrusion and tend to be dispersed better in extrudable polymers than fluoropolymers having similar Mooney viscosities and a linear chain topography.

Some of the amorphous fluoropolymers having a first Mooney viscosity or a second Mooney viscosity described above in any of their embodiments are available from commercial sources. For example, copolymers of hexafluoropropylene and vinylidene fluoride are commercially available from 3M Company, St. Paul, Minn., under the trade designations as “3M DYNAMAR FX 9613”, “3M DYNEON FLUOROELASTOMER FC 1650”, “3M DYNEON ULTRA HIGH VISCOSITY FLUOROELASTOMER FC 2299”, and “3M DYNEON FLUOROELASTOMER FC 2178”. Other useful fluoropolymers are commercially available from E.I. duPont de Nemours and Co., Wilmington, Del., under the trade designations “VITON A” and “VITON FREEFLOW” in various grades and from Daikin Industries, Ltd., Osaka, Japan, under the trade designation “DAI-EL” in various grades.

Other amorphous fluoropolymers described above can be made using conventional methods. Amorphous fluoropolymers useful for practicing the present disclosure, including those described in any of the above embodiments, are typically prepared by a sequence of steps, which can include polymerization, coagulation, washing, and drying. In some embodiments, an aqueous emulsion polymerization can be carried out continuously under steady-state conditions. For example, an aqueous emulsion of monomers (e.g., including any of those described above), water, emulsifiers, buffers and catalysts can be fed continuously to a stirred reactor under optimum pressure and temperature conditions while the resulting emulsion or suspension is continuously removed. In some embodiments, batch or semibatch polymerization is conducted by feeding the aforementioned ingredients into a stirred reactor and allowing them to react at a set temperature for a specified length of time or by charging ingredients into the reactor and feeding the monomers into the reactor to maintain a constant pressure until a desired amount of polymer is formed. After polymerization, unreacted monomers are removed from the reactor effluent latex by vaporization at reduced pressure. The fluoropolymer can be recovered from the latex by coagulation.

The polymerization is generally conducted in the presence of a free radical initiator system, such as ammonium persulfate, potassium permanganate, AIBN, or bis(perfluoroacyl) peroxides. The polymerization reaction may further include other components such as chain transfer agents and complexing agents. The polymerization is generally carried out at a temperature in a range from 10° C. and 100° C., or in a range from 30° C. and 80° C. The polymerization pressure is usually in the range of 0.3 MPa to 30 MPa, and in some embodiments in the range of 2 MPa and 20 MPa.

When conducting emulsion polymerization, perfluorinated or partially fluorinated emulsifiers may be useful. Generally these fluorinated emulsifiers are present in a range from about 0.02% to about 3% by weight with respect to the polymer. Polymer particles produced with a fluorinated emulsifier typically have an average diameter, as determined by dynamic light scattering techniques, in range of about 10 nanometers (nm) to about 300 nm, and in some embodiments in range of about 50 nm to about 200 nm. If desired, the emulsifiers can be removed or recycled from the fluoropolymer latex as described in U.S. Pat. No. 5,442,097 to Obermeier et al., U.S. Pat. No. 6,613,941 to Felix et al., U.S. Pat. No. 6,794,550 to Hintzer et al., U.S. Pat. No. 6,706,193 to Burkard et al. and U.S. Pat. No. 7,018,541 to Hintzer et al. In some embodiments, the polymerization process may be conducted with no emulsifier (e.g., no fluorinated emulsifier). Polymer particles produced without an emulsifier typically have an average diameter, as determined by dynamic light scattering techniques, in a range of about 40 nm to about 500 nm, typically in range of about 100 nm and about 400 nm, and suspension polymerization will typically produce particles sizes up to several millimeters.

In some embodiments, a water soluble initiator can be useful to start the polymerization process. Salts of peroxy sulfuric acid, such as ammonium persulfate, are typically applied either alone or sometimes in the presence of a reducing agent, such as bisulfites or sulfinates (e.g., fluorinated sulfinates disclosed in U.S. Pat. Nos. 5,285,002 and 5,378,782 both to Grootaert) or the sodium salt of hydroxy methane sulfinic acid (sold under the trade designation “RONGALIT”, BASF Chemical Company, New Jersey, USA). Most of these initiators and emulsifiers have an optimum pH-range where they show most efficiency. For this reason, buffers are sometimes useful. Buffers include phosphate, acetate or carbonate buffers or any other acid or base, such as ammonia or alkali metal hydroxides. The concentration range for the initiators and buffers can vary from 0.01% to 5% by weight based on the aqueous polymerization medium.

Aqueous polymerization using the initiators described above will typically provide amorphous fluoropolymers with polar end groups; (see, e.g., Logothetis, Prog. Polym. Sci., Vol. 14, pp. 257-258 (1989)). If desired, such as for improved processing or increased chemical stability, the presence of strong polar end groups such as SO₃⁽⁻⁾ and COO⁽⁻⁾ can be reduced in at least one of the first and second amorphous fluoropolymers through known post treatments (e.g., decarboxylation, post-fluorination). Chain transfer agents of any kind can significantly reduce the number of ionic or polar end groups. The strong polar end groups can be reduced by these methods to any desired level. In some embodiments, the number of polar functional end groups (e.g., —COF, —SO₂F, —SO₃M, —COO-alkyl, and —COOM, wherein alkyl is C₁-C₃ alkyl and M is hydrogen or a metal or ammonium cation), is reduced to less than or equal to 300, 200, or 100 per 10⁶ carbon atoms. In some embodiments, it may be useful to select initiators and polymerization conditions to achieve at least 300 polar functional end groups (e.g., —COF, —SO₂F, —SO₃M, —COO— alkyl, and —COOM, wherein alkyl is C₁-C₃ alkyl and M is hydrogen or a metal or ammonium cation) per 10⁶ carbon atoms, 400 per 10⁶ carbon atoms, or at least 500 per 10⁶ carbon atoms for at least one of the first or second amorphous fluoropolymers. When at least one of the first or second amorphous fluoropolymers has at least 300, 400, or 500 polar functional end groups per 10⁶ carbon atoms, the first or second may have increased interaction with a metal die surface as described in U.S. Pat. No. 5,132,368 (Chapman et al.) or may provide a melt-processable resin with improved moldability as described in U.S. Pat. Appl. No. 2011/0172338 (Murakami et al.) In some embodiments, one of the first or second amorphous fluoropolymer has at least 300, 400, or 500 polar functional end groups per 10⁶ carbon atoms, and the other of the first or second amorphous fluoropolymer has less than 300, 200, or 100 polar end groups per 10⁶ carbon atoms. If the first amorphous fluoropolymer and the second amorphous fluoropolymer are prepared and post-treated in the same way, the first amorphous fluoropolymer will typically have more polar end groups than the second amorphous fluoropolymer due to its lower molecular weight. The number of polar end groups can be determined by known infrared spectroscopy techniques.

Chain transfer agents and any long-chain branching modifiers described above can be fed into the reactor by batch charge or continuously feeding. Because feed amount of chain transfer agent and/or long-chain branching modifier is relatively small compared to the monomer feeds, continuous feeding of small amounts of chain transfer agent and/or long-chain branching modifier into the reactor can be achieved by blending the long-chain branding modifier or chain transfer agent in one or more monomers.

Adjusting, for example, the concentration and activity of the initiator, the concentration of each of the reactive monomers, the temperature, the concentration of the chain transfer agent, and the solvent using techniques known in the art can control the Mooney viscosity of the amorphous fluoropolymer.

In some embodiments, fluoropolymers useful for practicing the present disclosure have weight average molecular weights in a range from 10,000 g/mol to 200,000 g/mol. In some embodiments, the weight average molecular weight is at least 15,000, 20,000, 25,000, 30,000, 40,000, or 50,000 g/mol up to 100,000, 150,000, 160,000, 170,000, 180,000, or up to 190,000 g/mol. Fluoropolymers useful for practicing the present disclosure typically have a distribution of molecular weights and compositions. Weight average molecular weights can be measured, for example, by gel permeation chromatography (i.e., size exclusion chromatography) using techniques known to one of skill in the art.

To coagulate the obtained fluoropolymer latex, any coagulant which is commonly used for coagulation of a fluoropolymer latex may be used, and it may, for example, be a water soluble salt (e.g., calcium chloride, magnesium chloride, aluminum chloride or aluminum nitrate), an acid (e.g., nitric acid, hydrochloric acid or sulfuric acid), or a water-soluble organic liquid (e.g., alcohol or acetone). The amount of the coagulant to be added may be in range of 0.001 to 20 parts by mass, for example, in a range of 0.01 to 10 parts by mass per 100 parts by mass of the fluoropolymer latex. Alternatively or additionally, the fluoropolymer latex may be frozen for coagulation. The coagulated fluoropolymer can be collected by filtration and washed with water. The washing water may, for example, be ion exchanged water, pure water or ultrapure water. The amount of the washing water may be from 1 to 5 times by mass to the fluoropolymer, whereby the amount of the emulsifier attached to the fluoropolymer can be sufficiently reduced by one washing.

The first and second amorphous fluoropolymers useful for practicing the present disclosure can be combined in a number of ways. For example, the amorphous fluoropolymers can be produced by means of a suitable polymerization process (e.g., step polymerization). A step polymerization employs the use of specific initiators and chain transfer agents such as any of those described above. At the beginning of the polymerization, relatively little initiator and relatively little chain transfer agent are charged to the reaction vessel for a desired second Mooney viscosity. As the polymerization proceeds, additional initiator and chain transfer agent are charged to the reaction vessel. The exact timing and quantity of these charges will affect the polymerization conditions and permit the operator to produce a polymer having the desired characteristics. For example, after 50% of the starting monomers have been added, the further addition of appropriate amounts of initiator and chain transfer agent can be used to change the polymerization conditions and produce a polymer with a desired first Mooney viscosity. A desired first Mooney viscosity can also be achieved by increasing the temperature during the polymerization. In this way, fluoropolymer having a bimodal or multimodal molecular weight distribution can be made. “Multimodal” as used herein means that a fluoropolymer has at least two components of discrete and different molecular weights.

The first and second amorphous fluoropolymers may also be combined by mixing either the latexes or the powder products of the separate components. In some embodiments, a blend of the first and second amorphous fluoropolymers is prepared by mixing the latexes of the components (so-called latex blending) and subsequently finishing the mixture by co-coagulation using any of the methods described above.

The first and second amorphous fluoropolymers may also be combined in the non-fluorinated thermoplastic polymer as described in further detail, below. In these embodiments, each of the first and second amorphous fluoropolymer may be unimodal or multi-modal.

In some embodiments of the compositions and methods according to the present disclosure, the fluoropolymer can be used in combination with a polymer processing additive synergist. In some embodiments, the polymer processing additive synergist comprises at least one of poly(oxyalkylene) polymer, a silicone-polyether copolymer; an aliphatic polyester such as poly(butylene adipate), poly (lactic acid) and polycaprolactone polyesters; a polytetrafluoroethylene (e.g., a polytetrafluoroethylene micropowder), an aromatic polyester such as phthalic acid diisobutyl ester, or a polyether polyol. Blends of any of these classes of synergists may be useful. Also, block copolymers including blocks of two or more of these classes of synergists may be useful. For examples, the polymer processing additive synergist may be silicone-polycaprolactone block copolymer or a poly(oxyalkylene)-polycaprolactone block copolymer. In some embodiments, the polymer processing additive synergist comprises at least one of polycaprolactone or a poly(oxyalkylene).

Poly(oxyalkylene) polymers and other synergists may be selected for their performance in polymer processing additive blends. The (oxyalkylene) polymer or other synergist may be selected such that it (1) is in the liquid state (or molten) at a desired extrusion temperature and (2) has a lower melt viscosity than both the host polymer and the polymer processing additive. In some embodiments, it is believed the (oxyalkylene) polymer or other synergist associates with the surface of the polymer processing additive particles in extrudable compositions. For example, the (oxyalkylene) polymer or other synergist may wet the surfaces of the polymer processing additive particles in extrudable compositions.

Poly(oxyalkylene) polymers useful as polymer processing additive synergists can be represented by formula A[(OR¹)ₓOR²]_{y}, wherein A is typically alkylene interrupted by one or more ether linkages, y is 2 or 3, (OR¹)ₓ is a poly(oxyalkylene) chain having a plurality (x) of oxyalkylene groups, OR¹, wherein each R¹ is independently C₂ to C₅ alkylene, in some embodiments, C₂ to C₃ alkylene, x is about 3 to 3000, R² is hydrogen, alkyl, aryl, arylalkenyl, alkylarylenyl, —C(O)-alkyl, —C(O)-aryl, —C(O)-arylalkenyl, or —C(O)-alkylarylenyl, wherein —C(O)— is bonded to the O of OR². The variable “x” is selected such that molecular weight of the poly(oxyalkylene) polymer is in a range from about 200 to about 20,000 grams per mole (g/mol) or higher, in some embodiments about 400 to about 15,000 g/mol. In some embodiments, x is in a range from 5 to 1000 or 10 to 500. The poly(oxyalkylene) polymer chain can be a homopolymer chain such as poly (oxyethylene) in which each R¹ is —CH₂CH₂—, or poly(oxypropylene), in which each R¹ is —C₃H₆—. Or the poly(oxyalkylene) polymer chain can be a chain of randomly distributed oxyalkylene groups (e.g., a copolymer —OC₂H₄— and —OC₃H₆— units) or having alternating blocks of repeating oxyalkylene groups (e.g., a polymer comprising (—OC₂H₄—)ₐ and (—OC₃H₆—)_{b} blocks, wherein a+b is in a range from 5 to 5000 or higher, in some embodiments, 10 to 500. In some embodiments, A is ethylene, —CH₂—CH(−)—CH₂— (derived from glycerol), CH₃CH₂C(CH₂—)₃ (derived from 1,1,1-trimethylol propane), poly(oxypropylene), —CH₂CH₂—O—CH₂CH₂—, or —CH₂CH₂—O—CH₂CH₂—O—CH₂CH₂—. In some embodiments, R² is hydrogen, methyl, butyl, phenyl, benzyl, acetyl, benzoyl, or stearyl. Other useful poly(oxyalkylene) polymers are polyesters prepared, for example, from dicarboxylic acids and poly(oxyalkylene) polymers represented by formula A[(OR¹)ₓOR²]_{y}, wherein A, R¹, and x are as defined above, R² is hydrogen, and y is 2. Typically, the major proportion of the poly(oxyalkylene) polymer by weight will be the repeating oxyalkylene groups, (OR¹).

In some embodiments, the poly(oxyalkylene) polymers useful as polymer processing additive synergist are polyethylene glycols and their derivatives. Polyethylene glycol (PEG) can be represented by formula H(OC₂H₄)_{x′}OH, where x′ is about 15 to 3000. Many of these polyethylene glycols, their ethers, and their esters are commercially available from a variety of sources. Polyethylene glycol-polycaprolactone block copolymers may also be useful.

While the first and second amorphous fluoropolymers can be used in combination with a polymer processing additive synergist, the examples below show that a blend of the first and second amorphous fluoropolymers is effective as a polymer processing additive in the absence of a synergist. Accordingly, the compositions according to the present disclosure can be essentially free of a polymer processing additive synergist, including any of those described above. “Essentially free of a polymer processing additive synergist” can refer to compositions including a polymer processing additive synergist but in an amount that may be ineffective for improving the melt fracture performance during an extrusion when the polymer processing additive composition is included in a host resin. In some embodiments, the polymer processing additive composition may include up to or less than 1, 0.5, 0.25, or 0.1 percent by weight of a polymer processing additive synergist. Being “essentially free of a polymer processing additive synergist” can include being free of a polymer processing additive synergist.

In embodiments in which the composition according to the present disclosure includes a polymer processing additive synergist, typically, the composition comprises between about 5 and 95 weight percent of the synergist and 95 and 5 weight percent of the amorphous fluoropolymers. The ratio of the amorphous fluoropolymers to the synergist component in the polymer processing additive can be from 2:1 to 1:10, in some embodiments 1:1 to 1:5.

In embodiments in which the composition according to or useful for practicing the present disclosure includes a poly(oxyalkylene) synergist, it may be useful for the composition to include a metal salt of a carboxylic acid, sulfonic acid, or alkylsulfate is useful for thermally stabilizing a poly(oxyalkylene) polymer. In some embodiments, the metal salt is a metal salt of a carboxylic acid or a sulfonic acid. Carboxylic acids and sulfonic acids may be monofunctional or multifunctional (e.g., difunctional) and may be aliphatic or aromatic. In other words, the carbonyl carbon or sulfonyl sulfur may be attached to an aliphatic group or aromatic ring. Aliphatic carboxylic acids and sulfonic acids may be saturated or unsaturated. In addition to the one or more —C(O)O⁻ or —S(O)₂O⁻ anions (i.e., carboxylate or sulfonate groups, respectively), the aliphatic or aromatic group may also be substituted by other functional groups including halogen (i.e., fluoro, chloro, bromo, and iodo), hydroxyl, and alkoxy groups, and aromatic rings may also be substituted by alkyl groups. In some embodiments, the carboxylic acid or sulfonic acid is monofunctional or difunctional and aliphatic, without any further substituents on the aliphatic chain. In some embodiments, the carboxylic acid is a fatty acid, for example, having an alkyl or alkenyl group with about 8 to 30 (in some embodiments, 8 to 26 or 8 to 22) carbon atoms. The common names of the fatty acids having from eight to twenty six carbon atoms are caprylic acid (C₈), capric acid (C₁₀), lauric acid (C₁₂), myristic acid (C₁₄), palmitic acid (C₁₆), stearic acid (C₁₈), arachidic acid (C₂₀), behenic acid (C₂₂), lignoceric acid (C₂₄), and cerotic acid (C₂₆). Fatty acid metal salts of these acids may be caprylate, caprate, laurate, myristate, palmitate, stearate, arachidate, behenate, lignocerate, and cerotate salts, in some embodiments. In some embodiments the carboxylic acid is other than stearic acid. Examples of useful metal cations in the metal salt of a carboxylic acid, sulfonic acid, or alkylsulfate include aluminum (Al), calcium (Ca), magnesium (Mg), zinc (Zn), barium (Ba), lithium (Li), sodium (Na), and potassium (K). In some embodiments, the metal salt is a sodium or potassium salt. In some embodiments, the metal salt is a zinc or calcium salt. Examples of metal salts of a carboxylic acid, sulfonic acid, or alkylsulfate useful for thermally stabilizing a poly(oxyalkylene) polymer in compositions and methods according to the present disclosure include calcium stearate, zinc stearate, barium stearate, aluminum stearate, potassium stearate, magnesium stearate, sodium stearate, zinc acetate, sodium acetate, sodium caprylate, sodium laurate, sodium behenate, sodium 1-decane sulfonate, sodium lauryl sulfate, and zinc phthalate. In some embodiments, the metal salt is other than calcium stearate or zinc stearate. In some embodiments, the metal salt is other than calcium stearate. For more information regarding such metal salts and their ability to stabilize a poly(oxyalkylene) polymer, see Int. Pat. Appl. Publ. No. WO2015/042415 (LavaHee et al.).

In some embodiments, the first and second amorphous fluoropolymers disclosed herein can be used in combination with a silicone-containing polymer or another fluoropolymer polymer processing additive (e.g., a semicrystalline fluoropolymer). Semicrystalline fluoropolymers that are useful for at least partially alleviating melt defects in extrudable thermoplastic polymers and can be used in combination with the first and second amorphous fluoropolymer composition disclosed herein include those described, for example, in U.S. Pat. No. 5,527,858 (Blong et al.) and U.S. Pat. No. 6,277,919 (Dillon et al.). Some useful semicrystalline fluoropolymers include copolymers of vinylidene fluoride, tetrafluoroethylene, and hexafluoropropylene and are commercially available from 3M Company under the trade designations “DYNAMAR FX 5911”, and “DYNAMAR FX 5912” and fluoropolymers available from Arkema, Colombes, France, under the trade designation “KYNAR” in various grades. Silicones that are useful for at least partially alleviating melt defects in extrudable thermoplastic polymers and can be used in combination with the first and second amorphous fluoropolymer disclosed herein include polysiloxanes described, for example, in U.S. Pat. No. 4,535,113 (Foster et al.), polydiorganosiloxane polyamide block copolymers and polydiorganosiloxane polyoxamide block copolymers described, for example, in U.S. Pat. App. Pub. No. 2011-0244159 (Papp et al.), and silicone-polyurethane copolymers described, for example, in Int. Pat. Appl. Publ. No. WO2015/042415 (Lavallée et al.). Some silicone polymer processing additives are commercially available, for example, from Dow Corning, Midland, Mich., under the trade designation “DOW CORNING MB50-002” and Wacker Chemie AG, Munich, Germany, under the trade designation “GENIOPLAST”.

While the first and second amorphous fluoropolymer disclosed herein can be used in combination with another polymer processing additive, the examples below show that the first and second fluoropolymers are effective as a polymer processing additive in the absence of any other polymer processing additive. Accordingly, the compositions according to the present disclosure can be essentially free of other, different fluoropolymers (that is, not have the claimed first and second Mooney viscosities). “Essentially free of other, different fluoropolymers” can refer to compositions including other fluoropolymers but in an amount that may be ineffective for improving the melt fracture performance during an extrusion when the polymer processing additive composition is included in a host resin. In some embodiments, the polymer processing additive composition may include up to or less than 1, 0.5, 0.25, or 0.1 percent by weight of other, different fluoropolymers. Being “essentially free of other, different fluoropolymers” can include being free of a second, different fluoropolymer.

First and second amorphous fluoropolymers and blends thereof useful for practicing the present disclosure, which may include a polymer processing additive synergist, may be used in the form of powders, pellets, granules of the desired particulate size or size distribution, or in any other extrudable form. These compositions, useful as polymer processing additive compositions, can contain conventional adjuvants such as antioxidants, hindered amine light stabilizers (HALS), UV stabilizers, metal oxides (e.g., magnesium oxide and zinc oxide), antiblocks (e.g., coated or uncoated), pigments, and fillers (e.g., titanium dioxide, carbon black, and silica).

HALS are typically compounds that can scavenge free-radicals, which can result from oxidative degradation. Some suitable HALS include a tetramethylpiperidine group, in which the nitrogen atoms on the piperidine may be unsubstituted or substituted by alkyl or acyl. Examples of suitable HALS include decanedioic acid, bis(2,2,6,6-tetramethyl-1-(octyloxy)-4-piperidinyl)ester, bis(2,2,6,6-tetramethyl-4-piperidyl)sebacate, 8-acetyl-3-dodecyl-7,7,9,9-tetramethyl-1,3,8-triazaspiro(4,5)-decane-2,5-dione, bis(2,2,6,6-tetramethyl-4-hydroxypiperidine succinate), and bis(N-methyl-2,2,6,6-tetramethyl-4-piperidyl)secacate. Suitable HALS further include those available, for example, from BASF, Florham Park, N.J., under the trade designations “CHIMASSORB”. Examples of antioxidants include those obtained under the trade designations “IRGAFOS 168”, “IRGANOX 1010” and “ULTRANOX 626”, also available from BASF. These stabilizers, if present, can be included in the compositions according to the present disclosure in any effective amount, typically up to 5, 2, to 1 percent by weight based on the total weight of the composition and typically at least 0.1, 0.2, or 0.3 percent by weight.

In some embodiments, compositions according to the present disclosure include a non-fluorinated host polymer. Generally, the non-fluorinated polymer is a thermoplastic, melt-processable polymer. The term “non-fluorinated” can refer to polymers having a ratio of fluorine atoms to carbon atoms of less than 1:2, in some embodiments, less than 1:3, 1:5, 1:10, 1:25, or 1:100. A non-fluorinated, thermoplastic polymer may a no fluorine atoms. A wide variety of thermoplastic polymers are useful. Examples of useful thermoplastic polymers include non-fluorinated polymers such as hydrocarbon resins, polyamides (e.g., nylon 6, nylon 6/6, nylon 6/10, nylon 11 and nylon 12), polyester (e.g., poly (ethylene terephthalate), poly (butylene terephthalate)), and poly(lactic acid), chlorinated polyethylene, polyvinyl resins (e.g., polyvinylchoride, polyacrylates and polymethylacrylates), polycarbonates, polyketones, polyureas, polyimides, polyurethanes, polyolefins and polystyrenes.

Useful melt-processable polymers have melt flow indexes (measured according to ASTM D1238 at 190° C., using a 2160-gram weight) of 5.0 grams per 10 minutes or less, or 2.0 grams per 10 minutes or less. Generally the melt flow indexes of melt-processable polymers are at least 0.1 or 0.2 grams per 10 minutes.

In some embodiments of the compositions and methods according to the present disclosure, useful thermoplastic polymers are hydrocarbon polymers, for example, polyolefins. Examples of useful polyolefins include those having the general structure CH₂═CHR³, wherein R³ is a hydrogen or alkyl. In some embodiments, the alkyl radical includes up to 10 carbon atoms or from one to six carbon atoms. Melt-processable polyolefins include polyethylene, polypropylene, poly (1-butene), poly (3-methylbutene), poly (4-methylpentene), copolymers of ethylene with propylene, 1-butene, 1-hexene, 1-octene, 1-decene, 4-methyl-1-pentene, and 1-octadecene, blends of polyethylene and polypropylene, linear or branched low-density polyethylenes (e.g. those having a density of from 0.89 to 0.94 g/cm³), high-density polyethylenes (e.g., those having a density of e.g. from 0.94 to about 0.98 g/cm³), and polyethylene and olefin copolymers containing copolymerizable monomers (e. g., ethylene and acrylic acid copolymers; ethylene and methyl acrylate copolymers; ethylene and ethyl acrylate copolymers; ethylene and vinyl acetate copolymers; ethylene, acrylic acid, and ethyl acrylate copolymers; and ethylene, acrylic acid, and vinyl acetate copolymers). Melt-processable polymers include the metallic salts of the olefin copolymers, or blends thereof, which contain free carboxylic acid groups (e.g., polymers that include copolymerized acrylic acid). Illustrative of the metals that can be used to provide the salts of said carboxylic acids polymers are the one, two, and three valence metals such as sodium, lithium, potassium, calcium, magnesium, aluminum, barium, zinc, zirconium, beryllium, iron, nickel, and cobalt.

The polyolefins useful for practicing the present disclosure may be obtained by the homopolymerization or copolymerization of olefins. Useful polyolefins may be copolymers of one or more olefins and up to about 30 weight percent or more, in some embodiments, 20 weight percent or less, of one or more monomers that are copolymerizable with such olefins. Representative monomers that are copolymerizable with the olefins include: vinyl ester monomers such as vinyl acetate, vinyl propionate, vinyl butyrate, vinyl chloroacetate, and vinyl chloropropionate; acrylic and alpha-alkyl acrylic acid monomers and their alkyl esters, amides, and nitriles such as acrylic acid, methacrylic acid, ethacrylic acid, methyl acrylate, ethyl acrylate, N,N-dimethyl acrylamide, methacrylamide, and acrylonitrile; vinyl aryl monomers such as styrene, o-methoxystyrene, p-methoxystyrene, and vinyl naphthalene; vinyl and vinylidene halide monomers such as vinyl chloride, vinylidene chloride, and vinylidene bromide; alkyl ester monomers of maleic and fumaric acid and anhydrides thereof such as dimethyl maleate, diethyl maleate, and maleic anhydride; vinyl alkyl ether monomers such as vinyl methyl ether, vinyl ethyl ether, vinyl isobutyl ether, and 2-chloroethyl vinyl ether; vinyl pyridine monomers; N-vinyl carbazole monomers; and N-vinyl pyrolidine monomers.

In some embodiments, a polyolefin useful in the compositions and methods disclosed herein is prepared by Ziegler-Natta catalysis. In some embodiments, a polyolefin useful in the compositions and methods disclosed herein is prepared by homogeneous catalysis. In some embodiments, homogeneous catalysis refers to catalysis in which the catalyst and the substrate are in the same phase (e.g., in solution). In some embodiments, homogeneous catalysis refers to catalysis carried out by catalysts having a single active site. Single site catalysts typically contain a single metal center.

In some embodiments, the homogeneously catalyzed polyolefin is a metallocene-catalyzed polyolefin. Metallocene catalysts typically have one or two cyclopentadienyl anions complexed to a positively charged metal such as zirconium, titanium, or hafnium. It is understood that the cyclopentadienyl groups can be substituted (e.g., by an alkyl, phenyl, or silyl group) or fused to an aromatic ring such as benzene, and two cyclopentadienyl groups or one cyclopentadienyl group and another coordinating group (e.g., N-alkyl, P-alkyl, O, or S) can be connected together through a bridging group (e.g., (CH₃)₂Si, (CH₃)₂C, or CH₂CH₂). The metal can include other ligands such as halogen, hydrogen, alkyl, phenyl, or an additional cyclopentadienyl group. Metallocene catalysts are typically used in combination with methyl alumoxane or borates under homogeneous reaction conditions.

Commercially available metallocene-catalyzed polyolefins include those from Exxon Chemical Company, Baytown, Tex., under the trade designations “EXXPOL”, “EXACT”, “EXCEED”, and “VISTAMAXX”, and from Dow Chemical Company, Midland, Mich., under the trade designations “AFFINITY” and “ENGAGE”.

Homogeneous or single-site catalysts other than metallocene catalysts are also useful for providing homogeneously catalyzed polyolefins. Such catalysts typically include at least one first ligand strongly bonded to a metal (e.g., zirconium, titanium, hafnium, palladium, or nickel) and at least one other ligand that may be labile. The first ligands typically remain bonded to the metal after activation (e.g., by methyl alumoxane or borate), stabilize the single form of the catalyst, do not interfere with polymerization, provide shape to the active site, and electronically modify the metal. Some useful first ligands include bulky, bidentate diimine ligands, salicylimine ligands, tridentate pyridine diimine ligands, hexamethyldisilazane, bulky phenolics, and acetylacetonate. Many of these ligands are described, for example, in Ittel et al., Chem. Rev., 2000, 100, 1169-1203. Other single site catalysts such as those described by Nova Chemicals Corporation, Calgary, Canada, under the trade designation “ADVANCED SCLAIRTECH TECHNOLOGY”.

Homogeneously catalyzed polyolefins may have higher molecular weights, lower polydispersity, fewer extractables, and different stereochemistry than polyolefins made by other methods such as Ziegler-Natta catalysis. Homogeneous catalysis also allows for a broader selection of polymerizable monomers than Ziegler-Natta catalysis. Ziegler-Natta catalysis, which employs halogenated transition metal complexes mixed with organometallic compounds, can leave acidic residues in the resultant polyolefin resin. Acid-neutralizing additives such as calcium stearate and zinc stearate have been added to such resins. For homogeneously catalyzed polyolefins, such acidic residues are generally not present; therefore acid-neutralizing additives may not be required.

Examples of useful homogeneously catalyzed polyolefins include those having the general structure CH₂═CHR³, wherein R³ is a hydrogen or alkyl. In some embodiments, alkyl includes up to 10 carbon atoms or from one to six carbon atoms. Homogeneously catalyzed polyolefins can include polyethylene, polypropylene, poly (1-butene), poly (3-methylbutene), poly (4-methylpentene), copolymers of ethylene with propylene, 1-butene, 1-hexene, 1-octene, 1-decene, 4-methyl-1-pentene, and 1-octadecene, blends of polyethylene and polypropylene, linear or branched low-density polyethylenes (e.g. those having a density of from 0.89 to 0.94 g/cm³), and high-density polyethylenes (e.g., those having a density of e.g. from 0.94 to about 0.98 g/cm³). In some embodiments, the homogeneously catalyzed polyolefin is linear low density polyethylene. In any of these embodiments, the homogeneously catalyzed polyolefin may be a metallocene-catalyzed polyolefin.

Compositions including non-fluorinated, thermoplastic polymers useful for practicing any of the embodiments of the present disclosure can contain any of the conventional adjuvants described above in any of their embodiments such as antioxidants, hindered amine light stabilizers (HALS), UV stabilizers, metal oxides (e.g., magnesium oxide and zinc oxide), antiblocks (e.g., coated or uncoated), pigments, and fillers (e.g., titanium dioxide, carbon black, and silica).

The non-fluorinated, thermoplastic polymers may be used in the form of powders, pellets, granules, or in any other extrudable form. Compositions according to the present disclosure can be prepared by any of a variety of ways. For example, the first and second amorphous fluoropolymers or blend thereof can be mixed with the non-fluorinated, thermoplastic polymers during the extrusion into polymer articles. Compositions according to the present disclosure can also include so-called masterbatches, which may contain the first and second amorphous fluoropolymers or a blend thereof, further components (e.g., synergist or adjuvants described above), and/or one or more host thermoplastic polymers. A masterbatch can be a useful, diluted form of a polymer processing additive. Masterbatches can contain the first and second amorphous fluoropolymer, and optionally a synergist, dispersed in or blended with a host polymer, which can be a polyolefin, homogeneously catalyzed polyolefin, metallocene-catalyzed polyolefin, or any of the non-fluorinated thermoplastics described above. Preparation of a masterbatch may allow for more accurate amounts of a polymer processing additive to be added to an extrudable composition, for example. The masterbatch may be a composition ready to be added to a thermoplastic polymer for being extruded into a polymer article. Masterbatches, which include concentrations of polymer processing additives as described below, are often prepared at relatively high temperatures under aerobic conditions. In some embodiments in which the masterbatch includes a poly(oxyalkylene) polymer synergist, a metal salt of a carboxylic acid, sulfonic acid, or alkylsulfate as described above in any of its embodiments may be useful as a stabilizer.

The masterbatches can also be prepared by blending the first and second amorphous fluoropolymers with other additives to be used in the formulation and optionally polyethylene resin, and forming them into a compressed pellet using a method according to or similar to the one described in U.S. Pat. Appl. Publ. No. 2010/0298487 (Bonnet et al.).

The non-fluorinated, thermoplastic polymer (in some embodiments, polyolefin) to be extruded and the polymer processing additive composition can be combined together by any of the blending means usually employed in the plastics industry, such as with a compounding mill, a Banbury mixer, or a mixing extruder in which the polymer processing additive composition is uniformly distributed throughout the host thermoplastic polymer. The mixing operation is most conveniently carried out at a temperature above the softening point of fluoropolymer and/or the synergist although it is also possible to dry-blend the components as particulates and then cause uniform distribution of the components by feeding the dry blend to a twin-screw melt extruder.

In some embodiments, the compositions and/or extrudable compositions according to the present disclosure can be made by mixing the first and second amorphous fluoropolymers, non-fluorinated, thermoplastic, and optionally synergist together simultaneously. In some embodiments, the first and second amorphous fluoropolymer are first combined to form a blend (e.g., either by combining latexes or powder products as described above), which is then combined with the non-fluorinated, thermoplastic polymer. In some embodiments, one of the first or second amorphous fluoropolymers is first mixed with non-fluorinated, thermoplastic polymer to form a pre-composition, and then the other of the first or second amorphous fluoropolymers is mixed with the pre-composition to form the composition and/or extrudable composition according to the present disclosure. In other embodiments, two pre-compositions are first prepared, one pre-composition containing the first amorphous fluoropolymer and non-fluorinated, thermoplastic polymer, and the other pre-composition containing the second amorphous fluoropolymer and non-fluorinated, thermoplastic polymer. These two pre-compositions are then mixed to form the composition or extrudable composition disclosed herein.

The resulting mixture can be pelletized or otherwise comminuted into a desired particulate size or size distribution and fed to an extruder, which typically will be a single-screw extruder, that melt-processes the blended mixture. Melt-processing typically is performed at a temperature from 180° C. to 280° C., although optimum operating temperatures are selected depending upon the melting point, melt viscosity, and thermal stability of the blend. Different types of extruders that may be used to extrude the compositions disclosed herein are described, for example, by Rauwendaal, C., “Polymer Extrusion”, Hansen Publishers, p. 23-48, 1986. The die design of an extruder can vary, depending on the desired extrudate to be fabricated. For example, an annular die can be used to extrude tubing, useful in making fuel line hose, such as that described in U.S. Pat. No. 5,284,184 (Noone et al.).

Such compositions may be mixed with further non-fluorinated, thermoplastic polymer and/or further components to obtain a composition ready for processing into a polymer article. The composition may also contain all required ingredients and are ready for being extruded into a polymer article. The amount of amorphous fluoropolymer in these compositions is typically relatively low. Accordingly, the non-fluorinated, thermoplastic polymer is present in a major amount in the some embodiments of the composition according to the present disclosure. A major amount would be understood to be greater than 50 percent by weight of the composition. In some embodiments, the major amount is at least 60, 70, 75, 80, or 85 percent by weight of the composition. The exact amount used may be varied depending upon whether the extrudable composition is to be extruded into its final form (e. g., a film) or whether it is to be used as a masterbatch or processing additive which is to be (further) diluted with additional host polymer before being extruded into its final form.

Generally, the composition according to the present disclosure that contains a non-fluorinated, thermoplastic polymer, which in some embodiments is a homogeneously catalyzed or metallocene-catalyzed polyolefin composition, includes the first and second amorphous fluoropolymers disclosed herein in a combined weight in a range from about 0.002 to 50 weight percent (in some embodiments, 0.002 to 10 weight percent), based on the total weight of the composition. In some of these embodiments, the combined weight of the first and second amorphous fluoropolymers and the polymer processing additive synergist is in a range from 0.01 percent to 50 percent (in some embodiments, 0.002 to 10 weight percent), based on the total weight of the composition. In a masterbatch composition, the combined weight of the first and second amorphous fluoropolymers and any polymer processing additive synergist can be in a range from 1 percent to 50 percent, in some embodiments, 1 percent to 10 percent, 1 percent to 5 percent, 2 percent to 10 percent, or 2 percent to 5 percent, based on the total weight of the composition. If the composition is to be extruded into final form and is not further diluted by the addition of host polymer, it typically contains a lower concentration of first and second amorphous fluoropolymers. In some of these embodiments, the combined weight of the first and second amorphous fluoropolymers and any polymer processing additive synergist is in a range from about 0.002 to 2 weight percent, in some embodiments about 0.01 to 1 weight percent, or 0.01 to 0.2 weight percent, based on the total weight of the composition. The upper concentration of polymer processing additive used is generally determined by economic limitations rather than by any adverse physical effect of the concentration of the polymer processing additive.

The compositions according to the present disclosure may be extruded or processed in a variety of ways, which includes for example, extrusion of films, extrusion blow molding, injection molding, pipe, wire and cable extrusion, and fiber production.

The examples, below, demonstrate that use of a combination of amorphous fluoropolymers as a polymer processing additive is effective in reducing melt defects in thermoplastic polymers. In some cases, the presently claimed combination is unexpectedly more effective at reducing time to clear melt fracture than a blend disclosed in U.S. Pat. No. 6,599,982 (Oriani). For example, Comparative Example 9 uses a blend of amorphous fluoropolymers having Mooney viscosities ML 1+10 @ 121° C. of 75 and 54. Example 5 uses a blend of amorphous fluoropolymers having Mooney viscosities ML 1+10 @ 121° C. of 150 and 54, and Example 7 uses a blend of amorphous fluoropolymers having Mooney viscosities ML 1+10 @ 121° C. of 96 and 33. The Mooney viscosity ML 1+10 @ 121° C. of each of the three blends is between 65 and 70. Examples 5 and 7, which each include an amorphous fluoropolymer with a Mooney viscosity greater than 80, each cleared melt fracture in a blown film within 90 minutes while Comparative Example 9 did not.

### SOME EMBODIMENTS OF THE DISCLOSURE

In a first embodiment, the present disclosure provides a composition comprising:

a first amorphous fluoropolymer having a first Mooney viscosity ML 1+10 @ 121° C. less than 60;

a second amorphous fluoropolymer having a second Mooney viscosity ML 1+10 @ 121° C. greater than 80; and

at least one of a non-fluorinated, thermoplastic polymer as a major component of the composition or a polymer processing additive synergist.

In a second embodiment, the present disclosure provides the composition of the first embodiment, wherein the composition comprises the non-fluorinated, thermoplastic polymer.

In a third embodiment, the present disclosure provides the composition of the second embodiment, wherein the first and second amorphous fluoropolymers are present in a combined amount from 0.002 percent to 50 percent or 10 percent, based on the total weight of the composition.

In a fourth embodiment, the present disclosure provides the composition of any one of the first to third embodiments, wherein the composition comprises the polymer processing additive synergist, and wherein the polymer processing additive synergist is a poly(oxyalkylene) polymer, a silicone-polyether copolymer, an aliphatic polyester, an aromatic polyester, a polyether polyol, or a combination thereof.

In a fifth embodiment, the present disclosure provides the composition of the fourth embodiment, wherein the polymer processing additive synergist comprises at least one of a poly(oxyalkylene) polymer or a polycaprolactone.

In a sixth embodiment, the present disclosure provides the composition of the fifth embodiment, wherein the polymer processing additive synergist comprises the poly(oxyalkylene) polymer and further comprises a metal salt of a carboxylic acid, sulfonic acid, or alkylsulfate.

In a seventh embodiment, the present disclosure provides the composition of any one of the first to sixth embodiments, further comprising at least one of a silicone-polyether copolymer, a silicone-polycaprolactone copolymer, a polysiloxane, a polydiorganosiloxane polyamide copolymer, a polydiorganosiloxane polyoxamide copolymer, or a silicone-polyurethane copolymer.

In an eighth embodiment, the present disclosure provides the composition of any one of the first to seventh embodiments, wherein the first and second amorphous fluoropolymers are included in a blend.

In a ninth embodiment, the present disclosure provides the composition of the seventh embodiment, wherein the blend of the first amorphous fluoropolymer and the second amorphous fluoropolymer has a Mooney viscosity ML 1+10 @ 121° C. in a range from 30 to 120.

In a tenth embodiment, the present disclosure provides a method of reducing melt defects during the extrusion of a non-fluorinated, thermoplastic polymer, the method comprising:

combining a non-fluorinated, thermoplastic polymer, a first amorphous fluoropolymer having a first Mooney viscosity ML 1+10 @ 121° C. less than 60, and a second amorphous fluoropolymer having a second Mooney viscosity ML 1+10 @ 121° C. greater than 80 to provide an extrudable composition; and

extruding the extrudable composition.

In an eleventh embodiment, the present disclosure provides the method of the tenth embodiment, wherein the first and second amorphous fluoropolymers are present in a combined amount from 0.002 percent to 50 percent or 10 percent, based on the total weight of the extrudable composition.

In a twelfth embodiment, the present disclosure provides the method of the tenth or eleventh embodiment, further comprising combining a polymer processing additive synergist with the non-fluorinated, thermoplastic polymer, the first amorphous fluoropolymer, and the second amorphous fluoropolymer to make the extrudable composition.

In a thirteenth embodiment, the present disclosure provides the method of the twelfth embodiment, wherein the polymer processing additive synergist is a poly(oxyalkylene) polymer, a silicone-polyether copolymer, an aliphatic polyester, an aromatic polyester, a polyether polyol, or a combination thereof.

In a fourteenth embodiment, the present disclosure provides the method of the thirteenth embodiment, wherein the polymer processing additive synergist comprises at least one of a poly(oxyalkylene) polymer or a polycaprolactone.

In a fifteenth embodiment, the present disclosure provides the method of the fourteenth embodiment, wherein the polymer processing additive synergist comprises the poly(oxyalkylene) polymer and further comprises a metal salt of a carboxylic acid, sulfonic acid, or alkylsulfate.

In a sixteenth embodiment, the present disclosure provides the method of any one of the tenth to fifteenth embodiments, further comprising combining at least one of a silicone-polyether copolymer, a silicone-polycaprolactone copolymer, a polysiloxane, a polydiorganosiloxane polyamide copolymer, a polydiorganosiloxane polyoxamide copolymer, or a silicone-polyurethane copolymer with the non-fluorinated, thermoplastic polymer, the first amorphous fluoropolymer, and the second amorphous fluoropolymer to make the extrudable composition.

In a seventeenth embodiment, the present disclosure provides the method of any one of the tenth to sixteenth embodiments, further comprising blending the first amorphous fluoropolymer and the second amorphous fluoropolymer to form a blend and combining the blend with the non-fluorinated polymer.

In an eighteenth embodiment, the present disclosure provides the method of any one of the tenth to sixteenth embodiments, wherein the first amorphous fluoropolymer and the second amorphous fluoropolymer are added as separate components to the non-fluorinated polymer.

In a nineteenth embodiment, the present disclosure provides the method of any one of the tenth to eighteenth embodiments, wherein amounts of the first amorphous fluoropolymer and the second amorphous fluoropolymer are selected such that a blend of the first amorphous fluoropolymer and the second amorphous fluoropolymer has a Mooney viscosity ML 1+10 @ 121° C. in a range from 30 to 120.

In a twentieth embodiment, the present disclosure provides the composition or method of any one of the first to nineteenth embodiments, wherein the non-fluorinated, thermoplastic polymer comprises at least one of a polyolefin, polyamide, polyimide, polyurethane, polyester, polycarbonate, polyketone, polyurea, polystyrene, polyvinyl chloride, polyacrylate, or polymethacrylate.

In a twenty-first embodiment, the present disclosure provides the composition or method of the twentieth embodiment, wherein the non-fluorinated, thermoplastic polymer is a polyolefin.

In a twenty-second embodiment, the present disclosure provides the composition or method of the twenty-first embodiment, wherein the polyolefin is a homogeneously catalyzed polyolefin.

In a twenty-third embodiment, the present disclosure provides the composition or method of the twenty-first or twenty-second embodiment, wherein the polyolefin is a metallocene-catalyzed polyolefin.

In a twenty-fourth embodiment, the present disclosure provides the composition or method of any one of the twentieth to twenty-third embodiments, wherein the polyolefin is a linear low density polyethylene.

In a twenty-fifth embodiment, the present disclosure provides a polymer processing additive composition comprising:

a first amorphous fluoropolymer having a first Mooney viscosity ML 1+10 @ 121° C. less than 60;

a second amorphous fluoropolymer having a second Mooney viscosity ML 1+10 @ 121° C. greater than 80; and

a polymer processing additive synergist.

In a twenty-sixth embodiment, the present disclosure provides the polymer processing additive composition of the twenty-fifth embodiment, wherein the polymer processing additive synergist is a poly(oxyalkylene) polymer, a silicone-polyether copolymer, an aliphatic polyester, an aromatic polyester, a polyether polyol, or a combination thereof.

In a twenty-seventh embodiment, the present disclosure provides the polymer processing additive composition of the twenty-fifth or twenty-sixth embodiment, wherein the polymer processing additive synergist comprises at least one of a poly(oxyalkylene) polymer or a polycaprolactone.

In a twenty-eighth embodiment, the present disclosure provides the polymer processing additive composition of the twenty-seventh embodiment, wherein the polymer processing additive synergist comprises the poly(oxyalkylene) polymer and further comprises a metal salt of a carboxylic acid, sulfonic acid, or alkylsulfate.

In a twenty-ninth embodiment, the present disclosure provides the polymer processing additive composition of any one of the twenty-fifth to twenty-eighth embodiments, wherein a blend of the first amorphous fluoropolymer and the second amorphous fluoropolymer has a Mooney viscosity ML 1+10 @ 121° C. in a range from 30 to 120.

In a thirtieth embodiment, the present disclosure provides use of a combination of a first amorphous fluoropolymer having a first Mooney viscosity ML 1+10 @ 121° C. less than 60 and a second amorphous fluoropolymer having a second Mooney viscosity ML 1+10 @ 121° C. greater than 80 as a polymer processing additive.

In a thirty-first embodiment, the present disclosure provides the use of the thirtieth embodiment, wherein a blend of the first amorphous fluoropolymer and the second amorphous fluoropolymer has a Mooney viscosity ML 1+10 @ 121° C. in a range from 30 to 120.

In a thirty-second embodiment, the present disclosure provides the composition, method, or use of any one of the first to the thirty-first embodiments, wherein the first Mooney viscosity ML 1+10 @ 121° C. is in a range from 30 to 59, and wherein the second Mooney viscosity ML 1+10 @ 121° C. is in a range from 81 to 160.

In a thirty-third embodiment, the present disclosure provides the composition, method, or use of any one of the first to thirty-second embodiments, wherein the second Mooney viscosity ML 1+10 @ 121° C. is at least 90.

In a thirty-fourth embodiment, the present disclosure provides the composition, method, or use of any one of the first to thirty-third embodiments, wherein a difference between the first Mooney viscosity ML 1+10 @ 121° C. and the second Mooney viscosity ML 1+10 @ 121° C. is greater than 50.

In a thirty-fifth embodiment, the present disclosure provides the composition, method, or use of any one of the first to twenty-fourth embodiments, wherein a weight ratio of the first amorphous fluoropolymer and the second amorphous fluoropolymer is in a range from 20:80 to 80:20.

In a thirty-sixth embodiment, the present disclosure provides the composition, method, or use of any one of the first to thirty-fifth embodiments, wherein a blend of the first amorphous fluoropolymer and the second amorphous fluoropolymer has a Mooney viscosity ML 1+10 @ 121° C. in a range from 30 to 110.

In a thirty-seventh embodiment, the present disclosure provides the composition, method, or use of the thirty-sixth embodiment, wherein the blend of the first amorphous fluoropolymer and the second amorphous fluoropolymer has a Mooney viscosity ML 1+10 @ 121° C. in a range from 40 to 100.

In a thirty-eighth embodiment, the present disclosure provides the composition, method, or use of the thirty-sixth embodiment, wherein the blend of the first amorphous fluoropolymer and the second amorphous fluoropolymer has a Mooney viscosity ML 1+10 @ 121° C. in a range from 30 to 90.

In a thirty-ninth embodiment, the present disclosure provides the composition, method, or use of the thirty-sixth embodiment, wherein the blend of the first amorphous fluoropolymer and the second amorphous fluoropolymer has a Mooney viscosity ML 1+10 @ 121° C. in a range from 40 to 90.

In a fortieth embodiment, the present disclosure provides the composition, method, or use of the thirty-sixth embodiment, wherein the blend of the first amorphous fluoropolymer and the second amorphous fluoropolymer has a Mooney viscosity ML 1+10 @ 121° C. in a range from 30 to 60.

In a forty-first embodiment, the present disclosure provides the composition, method, or use of the thirty-sixth embodiments, wherein the blend of the first amorphous fluoropolymer and the second amorphous fluoropolymer has a Mooney viscosity ML 1+10 @ 121° C. in a range from 30 to 40.

In a forty-second embodiment, the present disclosure provides the composition, method, or use of the thirty-sixth embodiment, wherein the blend of the first amorphous fluoropolymer and the second amorphous fluoropolymer has a Mooney viscosity ML 1+10 @ 121° C. in a range from 60 to 90.

In a forty-third embodiment, the present disclosure provides the composition, method, or use of the thirty-sixth embodiment, wherein the blend of the first amorphous fluoropolymer and the second amorphous fluoropolymer has a Mooney viscosity ML 1+10 @ 121° C. in a range from 90 to 100.

In a forty-fourth embodiment, the present disclosure provides the composition, method, or use of the thirty-sixth embodiments, wherein the blend of the first amorphous fluoropolymer and the second amorphous fluoropolymer has a Mooney viscosity ML 1+10 @ 121° C. in a range from or 65 to 75.

In a forty-fifth embodiment, the present disclosure provides the composition, method, or use of any one of the first to forty-fourth embodiments, wherein the first amorphous fluoropolymer and the second amorphous fluoropolymer include the same or different monomer units selected from vinylidene fluoride, hexafluoropropylene, chlorotrifluoroethylene, 1-hydropentafluoropropylene, 2-hydropentafluoropropylene, tetrafluoroethylene, and propylene.

In a forty-sixth embodiment, the present disclosure provides the composition, method, or use of the forty-fifth embodiment, wherein the fluoropolymer comprises copolymerized units of hexafluoropropylene units and vinylidene fluoride units.

In a forty-seventh embodiment, the present disclosure provides the composition, method, or use of any one of the first to the forty-sixth embodiments, wherein the fluoropolymer is a terpolymer comprising copolymerized units of hexafluoropropylene units, vinylidene fluoride units, and tetrafluoroethylene units.

In a forty-eighth embodiment, the present disclosure provides the composition, method, or use of any one of the first to forty-seventh embodiments, wherein a number of polar functional end groups (e.g., —COF, —SO₂F, —SO₃M, —COO-alkyl, and —COOM, wherein alkyl is C₁-C₃ alkyl and M is hydrogen or a metal or ammonium cation) in at least one of the first or second amorphous fluoropolymers is less than or equal to 300, 200, or 100 per 10⁶ carbon atoms.

In a forty-ninth embodiment, the present disclosure provides the composition, method, or use of any one of the first to forty-eighth embodiments, wherein a number of polar functional end groups (e.g., —COF, —SO₂F, —SO₃M, —COO-alkyl, and —COOM, wherein alkyl is C₁-C₃ alkyl and M is hydrogen or a metal or ammonium cation) in at least one of the first or second amorphous fluoropolymers is greater than 300, 400, or 500 per 10⁶ carbon atoms.

In a fiftieth embodiment, the present disclosure provides the composition, method, or use of any one of the first to forty-ninth embodiments, wherein the composition, the polymer processing additive composition, or the extrudable composition further comprises at least one of an antioxidant or a hindered amine light stabilizer.

In order that this disclosure can be more fully understood, the following examples are set forth. It should be understood that these examples are for illustrative purposes only and are not to be construed as limiting this disclosure in any manner.

### EXAMPLES

All materials are commercially available, for example from Sigma-Aldrich Chemical Company; Milwaukee, Wis., or known to those skilled in the art unless otherwise stated or apparent.

These abbreviations are used in the following examples: g=gram, kg=kilograms, h=hour, min=minute, mm=millimeter, rpm=revolutions per minute, ppm=parts per million, sec=seconds, MV=Mooney viscosity.

### Materials

TABLE 1

| Material | Supplier |
|---|---|
| Marflex 7109 | A granular linear low density polyethylene |
| | resin available under the trade designation |
| | “Marflex 7109” from Chevron Phillips |
| | Chemical, The Woodlands, TX, USA |
| Poly Ethylene | Dow Chemical, Midland, MI, USA |
| Glycol, 8000 MW | |
| Poly Ethylene | Acres Organics, NJ, USA |
| Glycol, 100,000 MW | |
| FKM 150 | A fluorocarbon elastomer available under |
| | the trade designation “FC2299” from 3M |
| | Company, St. Paul, MN, USA |
| FKM96 | A fluorocarbon elastomer available under |
| | the trade designation “FC2178” from 3M |
| | Company, St. Paul, MN, USA |
| FKM 68 | A fluorocarbon elastomer available under |
| | the trade designation “FX9614” from 3M |
| | Company, St. Paul, MN, USA |
| FKM 75 | A fluorocarbon elastomer available under |
| | the trade designation “FX9614” from 3M |
| | Company, St. Paul, MN, USA |
| FKM 54 | A copolymer of VDF and HFP, with a |
| | fluorine content of 65.9% by weight, |
| | available under the trade designation “FE- |
| | 1000A” from 3M Company, St. Paul, MN, |
| | USA |
| FKM 48 | A fluorocarbon elastomer available under |
| | the trade designation “FC1650” from 3M |
| | Company, St. Paul, MN, USA |
| FKM 33 | A fluorocarbon elastomer available under |
| | the trade designation “FX9613” from 3M |
| | Company, St. Paul, MN, USA |
| Zinc Stearate | Alfa Aesar, Ward Hill, MA, USA |
| (ZnSt) | |
| Irganox B900 | BASF, Cleveland, OH, USA |
| EM 1002.09 | A granular linear low density polyethylene |
| | resin available under the trade designation |
| | “EM 1002.09” from ExxonMobil Chemical |
| | Company, Houston, TX, USA. |
| Silica | A fumed silica available under the trade |
| | designation “Cab-o-sil M5” from Cabot |
| | Corporation, Billerica, MA, USA. |
| Talc | Barretts Mineral (Specialty Minerals), |
| | Dillon, MT, USA |
| CaCO₃ | Imerys Pigments and Additive, Roswell, |
| | GA, USA |
| ABT 2500 | Ampacet MB # 101558, Tarrytown, NY, |
| | USA |
| Erucamide | Ampacet MB # 10090, Tarrytown, NY, |
| | USA |

### Preparation of Samples

### Method for Measuring Mooney Viscosity

The Mooney viscosity of unimodal amorphous fluoropolymers was measured after milling fluoropolymers on a laboratory Steward Bolling two roll mill (Serial No. 13380), roll size 16×8 inches and 1.3/1 roll speed ratio. The Mooney viscosities of blended, bimodal FKMs were measured after mill blending two unimodal amorphous fluoropolymers of the same composition but different molecular weight and Mooney viscosities FKMs (high and low). Mooney viscosity of each unimodal FKM and bimodal FKM blend is determined using ASTM D1646-06 Part A by a MV 2000 instrument (available from Alpha Technologies, Ohio, USA) using a large rotor (ML 1+10) at 121° C. Mooney viscosities specified above are in Mooney units. The measured Mooney viscosities are provided for unimodal amorphous fluoropolymers in Table 2 below and for bimodal blends of unimodal amorphous fluoropolymers in Table 3 below.

TABLE 2

| Unimodal | MV ML(1 + 10) |
|---|---|
| Fluoropolymers | @121° C. |
| FKM 150 | 150 |
| FKM 96 | 96 |
| FKM 68 | 68 |
| FKM 75 | 75 |
| FKM 54 | 54 |
| FKM 48 | 48 |
| FKM 33 | 33 |

TABLE 3

| Bimodal | MV ML(1 + 10) |
|---|---|
| Fluoropolymer Blends | @121° C. |
| 70% FKM 150 + 30% FKM 33 | 91 |
| 60% FKM 150 + 40% FKM 33 | 77 |
| 20% FKM 150 + 80% FKM 33 | 44 |
| 50% FKM 75 + 50% FKM 54 | 65 |
| 70% FKM 150 + 30% FKM 54 | 99 |
| 30% FKM 150 + 70% FKM 54 | 69 |
| 70% FKM 96 + 30% FKM 33 | 74 |
| 60% FKM 96 + 40% FKM 33 | 66 |

### Blending of Polymer Processing Additives (PPA)

Each amorphous fluoropolymer (FKM) listed in Table 2 above was ground using a Wiley grinder to pass through a 20 mesh screen. After grinding, talc was added at a concentration of 1% to each ground FKM to keep it free flowing.

For each PPA 1 through PPA 19, a 60 g batch was prepared by shaking vigorously in a plastic bag ground FKM(s), CaCO₃, talc, silica and, optionally, 40.2 g polyethylene glycol (PEG), as indicated in Table 4 below. For PPAs 1 through 4 and 9 through 16, the concentration of combined FKMs in the 60 g batch was 90% by mass. For PPAs 5 through 8 and 17 through 19, the concentration of combined FKMs in the 60 g batch was 30% by mass.

TABLE 4

| | FKM 150 | FKM 96 | FKM 68 | FKM 75 | FKM 54 | FKM 48 | FKM 33 | CaCO3 | Talc | Silica | PEG |
|---|---|---|---|---|---|---|---|---|---|---|---|
| PPA | (g) | (g) | (g) | (g) | (g) | (g) | (g) | (g) | (g) | (g) | (g) |
| PPA 1 | 54.55 | | | | | | | 1.2 | 3.05 | 1.2 | |
| PPA 2 | | 54.55 | | | | | | 1.2 | 3.05 | 1.2 | |
| PPA 3 | | | 54.55 | | | | | 1.2 | 3.05 | 1.2 | |
| PPA 4 | | | | | | | 54.55 | 1.2 | 3.05 | 1.2 | |
| PPA 5 | 18.18 | | | | | | | 0.6 | 1.02 | | 40.2 |
| PPA 6 | | 18.18 | | | | | | 0.6 | 1.02 | | 40.2 |
| PPA 7 | | | | | 18.18 | | | 0.6 | 1.02 | | 40.2 |
| PPA 8 | | | | | | 18.18 | | 0.6 | 1.02 | | 40.2 |
| PPA 9 | | | | 27.28 | 27.28 | | | 1.2 | 3.05 | 1.2 | |
| PPA 10 | 38.18 | | | | | | 16.36 | 1.2 | 3.05 | 1.2 | |
| PPA 11 | 32.72 | | | | | | 21.82 | 1.2 | 3.05 | 1.2 | |
| PPA 12 | 10.91 | | | | | | 43.63 | 1.2 | 3.05 | 1.2 | |
| PPA 13 | 38.18 | | | | 16.36 | | | 1.2 | 3.05 | 1.2 | |
| PPA 14 | 16.36 | | | | 38.18 | | | 1.2 | 3.05 | 1.2 | |
| PPA 15 | | 38.18 | | | | | 16.36 | 1.2 | 3.05 | 1.2 | |
| PPA 16 | | 32.72 | | | | | 21.82 | 1.2 | 3.05 | 1.2 | |
| PPA 17 | 12.73 | | | | | | 5.45 | 0.6 | 1.02 | | 40.2 |
| PPA 18 | | 12.73 | | | | | 5.45 | 0.6 | 1.02 | | 40.2 |
| PPA 19 | | 10.91 | | | | | 7.27 | 0.6 | 1.02 | | 40.2 |

### Preparation of Master Batches

PPAs were compounded into master batches (MB). The PPAs were compounded into 2 kg MBs at a level of 3% PPA. The MBs for PPAs 1 through 19 were prepared by shaking vigorously in a bag 1936.6 g granular LLDPE resin, 2.0 g Irganox B 900, 1.4 g Zinc Stearate, and 60 g of PPA. For each MB: the prepared mixture was fed to a laboratory scale, intermeshing, counter rotating, unvented, air cooled, conical twin screw (Haake Buchler Rheomix TW-100, Thermo Fisher Scientific) with a front inside diameter of 20 mm. The mixture was gravity fed to the throat of the extruder, exposed to air at a rate of 38 g/min. The extruder specific temperature profile of the 3 barrel zones (feed, metering, mixing), and die zone were 170/190/200/200° C. respectively. The extruder was run at 150 rpm for the first “compounding” pass. The second pass was run with the same temperature profile but at 90 rpm while flood feeding the material. A 4 min “purge” of material was discarded at the beginning each pass. Extruded strands were cut into pellets on each pass.

### Method for Measuring of Clearance of Melt Fracture

Clearance of melt fracture was evaluated using a Keifel Blown Film Line with a 40 mm, 21/1 grooved feed extruder to evaluate the Performance of PPAs listed above in Table 4 above. The die was of spiral design with a 40 mm diameter and a 0.9 mm die gap. The host resin was 0.9 MI Ziegler-Natta LLDPE (Marflex 7109 with 1.0 MI available from Chevron Phillips Chemicals). For each Example and Comparative Example, one MB, prepared as described above with a PPA indicated in Table 4, was combined at 350 ppm with 6000 ppm of ABT-2500 and 1000 ppm of Erucamide in the host resin matrix. The throughput rates in the system were adjusted between 10 and 11 kg/h, resulting in an apparent shear rate of approximately 220 sec⁻¹. The melt processing temperature was 210° C. (410° F.).

Prior to each evaluation it was necessary to ensure that the blown film line was free of residual fluoropolymer from the previous Example or Comparative Example. This was accomplished by extruding several extruder volumes full of an abrasive silica-containing purging compound, followed by an equal amount of the LLDPE resin with additives, but without PPA. This procedure was maintained before each blown film line evaluation. Prior to beginning each trial, 100% Melt Fracture was verified.

The percent melt fracture was determined by taking a section of the film lay flat, opening it along the edge, measuring the individual bands (regions) of melt fracture in the transverse direction of the film, summing their total, and then dividing by the total width of the opened lay flat film.

For each Example EX-1 through EX-10 and Comparative Example CE-1 through CE-9, once the baseline for the host resin was established, the resin containing PPA (PPA masterbatch, host resin and additive concentrates) was charged to the extruder and the time was recorded. At 10 min intervals a film sample was taken and inspected visually in terms of melt fracture elimination (% MF) until the film was free of MF or until the 90 min mark.

The results are provided in Table 5. The final pressure, recorded at 90 min or when Melt Fracture was 100% cleared, was also compared to the pressure recorded for the host resin without PPA and is presented in Table 5. The ratio of the difference between the final pressure and the initial pressure with the initial pressure, (P_{final}−Pᵢₙᵢₜᵢₐₗ)/Pᵢₙᵢₜᵢₐₗ, was expressed as % Pressure Reduction. The MV values provided in Table 5 refer to the MV provided in Table 2 for unimodal FKMs or provided in Table 3 for bimodal FKM blends and not to the compounded formulations of Table 4.

TABLE 5

| | | | Melt Fracture (%) | | | | | | | | | % Pressure |
|---|---|---|---|---|---|---|---|---|---|---|---|---|
| Example | PPA | MV | 10 min | 20 min | 30 min | 40 min | 50 min | 60 min | 70 min | 80 min | 90 min | Reduction |
| CE-1 | PPA 1 | 150 | 100 | 100 | 85 | 56 | 37 | 23 | 17 | 10 | 6 | 14.5 |
| CE-2 | PPA 2 | 96 | 100 | 64 | 20 | 8 | 2 | 1 | 0 | | | 18.8 |
| CE-3 | PPA 3 | 68 | 100 | 89 | 42 | 26 | 14 | 8 | 3 | 0.1 | 0 | 22 |
| CE-4 | PPA 4 | 33 | 100 | 100 | 100 | 100 | 100 | 99 | 89 | 79 | 68 | 1.9 |
| CE-5 | PPA 5 | 150 | 100 | 100 | 85 | 56 | 37 | 23 | 17 | 10 | 6 | 14.5 |
| CE-6 | PPA 6 | 96 | 100 | 66 | 29 | 12 | 7 | 3 | 1 | 0.5 | 0 | 19.9 |
| CE-7 | PPA 7 | 54 | 100 | 100 | 88 | 47 | 23 | 11 | 7 | 4 | 0 | 18.9 |
| CE-8 | PPA 8 | 48 | 100 | 100 | 100 | 89 | 71 | 57 | 36 | 22 | 15 | 13.2 |
| CE-9 | PPA 9 | 65 | 100 | 97 | 62 | 34 | 18 | 9 | 6 | 4.5 | 3 | 20.9 |
| EX-1 | PPA 10 | 91 | 100 | 78 | 49 | 23 | 12 | 6 | 3 | 2 | 1 | 14.8 |
| EX-2 | PPA 11 | 77 | 99 | 87 | 41 | 25 | 14 | 7 | 3 | 1.5 | 0.5 | 17.4 |
| EX-3 | PPA 12 | 44 | 100 | 100 | 86 | 58 | 32 | 19 | 7 | 3 | 1 | 13.6 |
| EX-4 | PPA 13 | 99 | 100 | 100 | 56 | 32 | 18 | 12 | 8 | 4.5 | 3 | 16.8 |
| EX-5 | PPA 14 | 69 | 100 | 100 | 67 | 32 | 16 | 10 | 3 | 1.5 | 0 | 20.5 |
| EX-6 | PPA 15 | 74 | 100 | 32 | 19 | 9 | 3.5 | 1.5 | 0.5 | 0 | | 19.4 |
| EX-7 | PPA 16 | 66 | 100 | 40 | 26 | 13 | 7 | 4 | 1.5 | 0 | | 20.6 |
| EX-8 | PPA 17 | 91 | 100 | 82 | 49 | 22 | 14 | 9 | 5 | 2.5 | 1 | 16.5 |
| EX-9 | PPA 18 | 74 | 100 | 61 | 16 | 7 | 3 | 1 | 0 | | | 21 |
| EX-10 | PPA 19 | 66 | 100 | 96 | 62 | 18 | 10 | 3.5 | 1.5 | 0.5 | 0.2 | 20.6 |

Various modifications and alterations of this disclosure may be made by those skilled the art without departing from the scope and spirit of the disclosure, and it should be understood that this invention is not to be unduly limited to the illustrative embodiments set forth herein.

1. A composition comprising:
a first amorphous fluoropolymer having a first Mooney viscosity ML 1+10 @ 121° C. less than 60;
a second amorphous fluoropolymer having a second Mooney viscosity ML 1+10 @ 121° C. greater than 80; and
at least one of a non-fluorinated polymer as a major component of the composition or a polymer processing additive synergist.

2. The composition of claim 1, wherein the first Mooney viscosity ML 1+10 @ 121° C. is in a range from 30 to 59, and wherein the second Mooney viscosity ML 1+10 @ 121° C. is in a range from 81 to 160.

3. The composition of claim 1, wherein the second Mooney viscosity ML 1+10 @ 121° C. is at least 90.

4. The composition of claim 1, wherein a difference between the first Mooney viscosity ML 1+10 @ 121° C. and the second Mooney viscosity ML 1+10 @ 121° C. is greater than 50.

5. The composition of claim 1, wherein a weight ratio of the first amorphous fluoropolymer and the second amorphous fluoropolymer is in a range from 20:80 to 80:20.

6. The composition of claim 1, wherein a blend of the first amorphous fluoropolymer and the second amorphous fluoropolymer has a Mooney viscosity ML 1+10 @ 121° C. in a range from 30 to 120.

7. The composition of claim 1, wherein the composition comprises the polymer processing additive synergist, and wherein the polymer processing additive synergist comprises at least one of a poly(oxyalkylene) polymer, a silicone-polyether copolymer, an aliphatic polyester, an aromatic polyester, or a polyether polyol.

8. The composition of claim 1, wherein the first amorphous fluoropolymer and the second amorphous fluoropolymer include the same or different monomer units selected from vinylidene fluoride, hexafluoropropylene, chlorotrifluoroethylene, 1-hydropentafluoropropylene, 2-hydropentafluoropropylene, tetrafluoroethylene, and propylene.

9. The composition of claim 1, wherein the composition comprises the non-fluorinated polymer, and wherein the non-fluorinated polymer comprises at least one of a polyolefin, polyamide, polyimide, polyurethane, polyester, polycarbonate, polyketone, polyurea, polystyrene, polyvinyl chloride, polyacrylate, or polymethacrylate.

10. The composition of claim 9, wherein the non-fluorinated polymer comprises at least one polyolefin.

11. A method of reducing melt defects during the extrusion of the non-fluorinated polymer, the method comprising extruding the composition of claim 1.

12. The method of claim 11, further comprising blending the first amorphous fluoropolymer and the second amorphous fluoropolymer to form a blend, and combining the blend with the non-fluorinated polymer.

13. The method of claim 11, wherein the first amorphous fluoropolymer and the second amorphous fluoropolymer are added as separate components to the non-fluorinated polymer.

14-15. (canceled)

16. The method of claim 11, wherein the non-fluorinated polymer comprises at least one of a polyolefin, polyamide, polyimide, polyurethane, polyester, polycarbonate, polyketone, polyurea, polystyrene, polyvinyl chloride, polyacrylate, or polymethacrylate.

17. The method of claim 11, wherein the non-fluorinated polymer comprises at least one polyolefin.

18. The composition of claim 7, wherein the polymer processing additive synergist comprises at least one of a poly(oxyalkylene) polymer or a polycaprolactone.

19. The composition of claim 1, wherein the composition comprises both the non-fluorinated polymer as a major component of the composition and the polymer processing additive synergist.

20. The composition of claim 1, further comprising at least one of a silicone-polyether copolymer, a silicone-polycaprolactone copolymer, a polysiloxane, a polydiorganosiloxane polyamide copolymer, a polydiorganosiloxane polyoxamide copolymer, or a silicone-polyurethane copolymer.

21. The composition of claim 1, wherein the fluoropolymer comprises copolymerized units of hexafluoropropylene and vinylidene fluoride.

22. The composition of claim 1, wherein the fluoropolymer is a terpolymer comprising copolymerized units of hexafluoropropylene, vinylidene fluoride, and tetrafluoroethylene.
